(19) United States
(12) Patent Application Publication
(10) Pub. No.: US 2005/0033854 A1
(43) Pub. Date: Feb. 10, 2005

(54) Method and apparatus for identifying a message source in a network

(75) Inventor: Jay D. Knitter, Wellington, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 10/635,815

(22) Filed: Aug. 7, 2003

(51) Int. Cl. G06F 15/16

(52) U.S. Cl. 709/230; 719/316

(57) ABSTRACT

A method and apparatus for identifying a message source in a network is provided including receiving a method call from a client computer to invoke an object on a data server, packaging the method call in a message to be sent from a client server to the data server via the network, on the client server, identifying the client computer from an execution stack, and transmitting the message to the data server.

### CORRESPONDING RELATED APPLICATIONS

This application is related to co-pending application Ser. No. 10/448,646 entitled “Graphical User Interface For Viewing Interactions Between Web Service Objects” filed on May 30, 2003, and co-pending application Ser. No. 10/449,555 entitled “Simulation of Network Service Test Environments” filed on May 30, 2003, the entire contents of which are incorporated by reference herein in their entirety.

### BACKGROUND OF THE INVENTION

Component software involves applications formed from a collection of individually built and updated software modules. These software modules are called components, each component providing a particular function (a.k.a. “Automation objects”) for the overall application. This hierarchy allows applications to be developed and updated more quickly and at a lower cost than in conventional techniques by adding new components and/or updating existing components without having to make changes to higher level applications themselves.

Protocols for invoking Automation objects have been developed. One such protocol layered on top of HTTP is called Simple Object Access Protocol (SOAP), which allows Automation objects to be invoked over the Internet via Web servers. This protocol is described, for example, in U.S. Pat. No. 6,457,066, which is incorporated by reference herein in its entirety.

The SOAP protocol encodes a SOAP request with the name of the Automation object to be invoked and a method to invoke/request that object. A client computer transmits the SOAP request to an Applications Programming Interface (API), such as Apache Axis, at a client server, which processes SOAP messages from a plurality of client computers. The client server further transfers SOAP messages to/from a data server on which the Automation object of interest resides, and returns parameters from invoked Automation objects to the client computers.

Programs for creating and/or implementing distributed component software (e.g., SOAP based software), however, suffer from various problems. By way of example, the high level of interaction in distributed component software makes testing and debugging this software more difficult. When developing a unified application, standard tools such as debuggers can be used to track program execution. However, distributed component software may involve multiple programs interacting on various computers anywhere in the world. These interactions may be hard to predict and track during run-time, especially since some public Web services may not be accessible by developers at a troubleshooting level.

### BRIEF DESCRIPTION OF THE DRAWINGS

FIG. 1 depicts a network according to an embodiment of the present invention.

FIG. 2 depicts a method of operating the network of FIG. 1 according to an embodiment of the present invention.

FIG. 3 depicts a method of operating the network of FIG. 1 according to another embodiment of the present invention.

FIG. 4 includes exemplary code for identifying a message source in the network of FIG. 1 according to an embodiment of the present invention.

FIG. 5 depicts a method of operating the network of FIG. 1 according to another embodiment of the present invention.

### DETAILED DESCRIPTION OF THE EMBODIMENTS

The following description will be provided in reference to a SOAP protocol as described above. However, it should be appreciated that the teachings of the present invention are applicable to other software and protocols, such as various TCP messaging protocols.

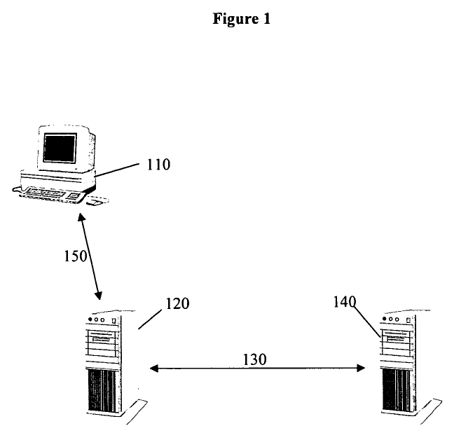

A network including a client computer 110, a client server 120, and a data server 140 according to an embodiment of the present invention is shown in FIG. 1. The client computer 110 is networked with client server 120 via network link 150, such as a LAN or WAN connection (e.g., an Ethernet link). The client server 120 is networked with data server 140 via network link 130, such as an internet connection. Other configurations are also plausible, and the network links 130 and/or 150 may link a plurality of client computers, client servers, and/or data servers, as would be readily apparent to one of ordinary skill in the art after reading this disclosure.

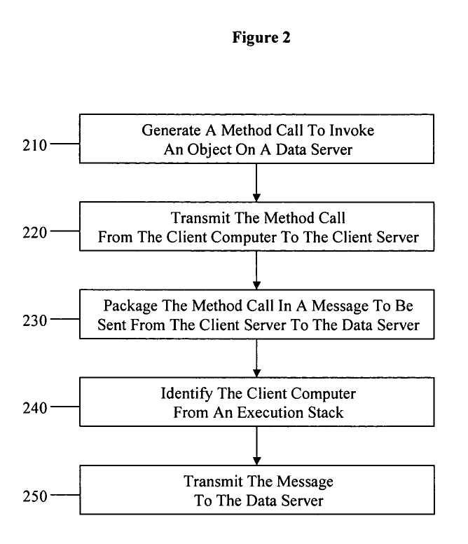

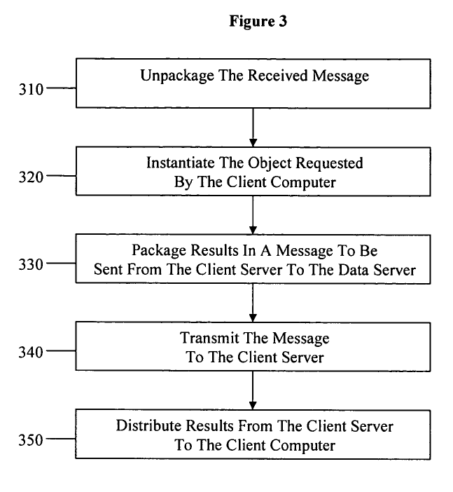

Operation of the network of FIG. 1 according to one embodiment of the present invention will now be described in reference to FIG. 2. In step 210, a software application running on the client computer 110 generates a method call to invoke an object (e.g., an automation object) on the data server 140. By way of example, an object on the client computer 110 may require a software component residing on the data server 140. After being generated on the client computer 110, the method call is then transmitted in step 220 from the client computer 110 to the client server 120 via network link 150. In step 230, the client server 120 then packages the received method call as a message (e.g., an HTTP post), which is subsequently transmitted in step 250 from the client server 120 to the data server 140 via network link 130. Step 240, which is not required for the basic operation of some protocols (e.g., SOAP), will be described in greater detail below after the processing of the message at the data server is described in reference to FIG. 3.

According to another embodiment of the present invention as shown in FIG. 3, upon receipt of the message, the data server 140 unpackages the received message in step 310 and instantiates the object requested by client computer 110 in step 320. The results from the instantiated object are then packaged in a return message (e.g., an HTTP post) in step 330, which is transmitted from the data server 140 to the client server 120 in step 340 via network link 130. The client server 120 then distributes the results in step 350 to the client computer 110 via network link 150. In this manner, the client computer 110 can request/invoke an object on data server 140.

In addition to the aforementioned characteristics, according to at least one embodiment of the present invention as shown in FIG. 2, the client server 120 is configured to identify the client computer 110 requesting/invoking the object on the data server 140 in step 240 (and/or a particular module/object running on client computer 110 which makes the request). Once the client computer 110 has been identified by the client server 120 in step 240 from an execution stack or the like, the client server 120 transmits an identifier of the client computer 110 (and/or the particular object running on client computer 110 which makes the request) along with the message to the data server 140 in step 250. While this identification is not necessarily required for the basic operations of a messaging protocol such as SOAP, the identification allows a network administrator to more easily debug problems with a distributed component system, by being able to identify the particular requester of a distributed component in the message itself (e.g., the requested/invoked object on data server 140).

One algorithm operable on the client server 120 for implementing the aforementioned embodiment is set forth below for purposes of illustration only. The exemplary code is provided in Java v1.3.1, though other code formats could also be used:

```
class Client {
  public static void main(String args[ ]) {
    Client2 c2 = new Client2( );
    c2.sendSOAPMessage( );
  }
}
class Client2 {
  public void sendSOAPMessage( ) {
    Client3 c3 = new Client3( );
    c3.findSourceOfSOAPMessage( );
  }
}
class Client3 {
  public void findSourceOfSOAPMessage( ) {
    Algorithm a = new Algorithm( );
    System.out.println(“Source of SOAP Message call: ” +
      a.findSourceOfSOAPMessageCall( ));
  }
}
class MySecurityManager extends SecurityManager {
  public MySecurityManager( ) {
    super( );
  }
  public Class[ ] getClassContext( ) {
    return super.getClassContext( );
  }
}
class Algorithm {
  //Define all known classes which clients call to send a SOAP
    message
  public static final String AXIS_SEND_SOAP_MESSAGE_CLASS =
    “org.apache.axis.client.Call”;
  public static final String
    EXAMPLE_SEND_SOAP_MESSAGE_CLASS = “Client2”;
  public String findSourceOfSOAPMessageCall( ) {
    //Create a new MySecurityManager so that we can call
      getClassContext( )
    MySecurityManager sm = new MySecurityManager( );
    //Get array of classes in execution stack
    Class[ ] classArray = sm.getClassContext( );
    //Iterate through each class in the execution stack
    for(int i=0; i<classArray.length; i+ +) {
      //Get the name of the next class that sends the SOAP
        message
      String fullyQualifiedClassName = classArray[i].getName( );
      if(fullyQualifiedClassName.equals(EXAMPLE_SEND_SOAP_MES
        SAGE_CLASS)) {
        //If the name matches the class that sends the SOAP
          message
        //then return the next class name in the execution stack
        //because it had to call the class that sends the SOAP
          message
        return classArray[i + 1].getName( );
      }
    }
    //If no matches are found then return null.
    return null;
  }
}
```

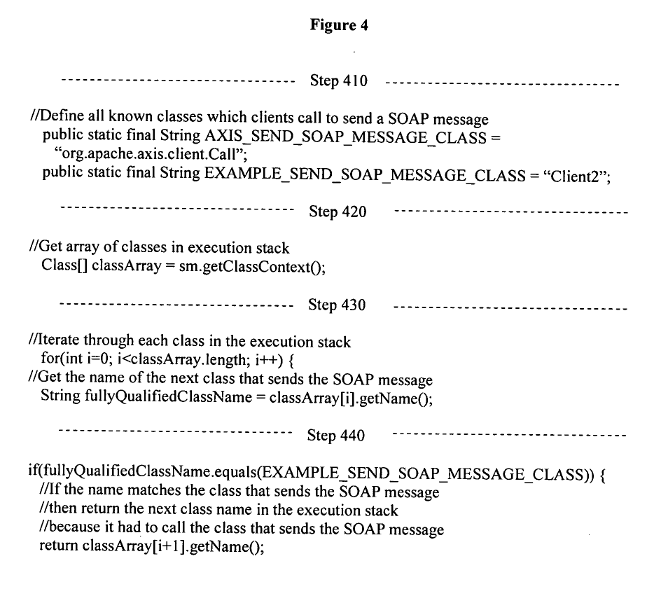

Basic operation of various portions of the aforementioned program will now be described in reference to FIG. 4. First, in step 410, class names are defined that the client code uses to send a SOAP message. Then, in step 420, a list of Class objects that represents the current execution stack is obtained. For each Class object in the list of Class objects (generally starting with the first in the list), the “fully qualified” name of the class is obtained in step 430, and the fully qualified name of the class is compared to the defined name of the class used to send SOAP message in step 440. If the names match in step 440, the fully qualified name of the next Class object in the list of the execution stack is obtained, and a String object (i.e., an identifier) representing the name of the class is returned.

It should be appreciated that a “fully qualified class name” as referenced above refers to a name used to reference an object class in Java. In Java, and most other object oriented languages, a package can be imported which allows a developer to reference the class by a shorter name. One such example in Java includes System.out (the fully qualified class name), which can be referred to as “out” (the unqualified class name) once the “System” package has been imported. Thus, the fully qualified class name is one example of an identifier that can be used according to various embodiments of the present invention.

If there are more elements in the list, then the process repeats, else there is no SOAP message to be sent remaining in the execution stack. The identifier (fully qualified class name) of the source of the SOAP call is stored in a SOAP header which is part of the message transmitted from the client computer 110 to the data server 140 (via client server 120). However, the entire stack is not in the header, only the class name that invoked the method to send the message to the data server 140. The identifier can the be retrieved by an administrator by simply examining the header of the message.

According to one embodiment of the present invention, the previously described source identification techniques can be used in conjunction with a component software developing/debugging program. Exemplary programs are described in co-pending applications entitled “Graphical User Interface For Viewing Interactions Between Web Service Objects” and “Simulation Of Network Service Test Environments” which are referenced above. According to this embodiment, a developing program may display a Web service graphical component representing the object generating the method call in step 210, and/or an interconnecting graphical component representing an associated interaction between the client computer 110 and data server 140 (e.g., messages traveling therebetween). Other features may also be provided, as would be readily apparent to one of ordinary skill in the art after reading this disclosure.

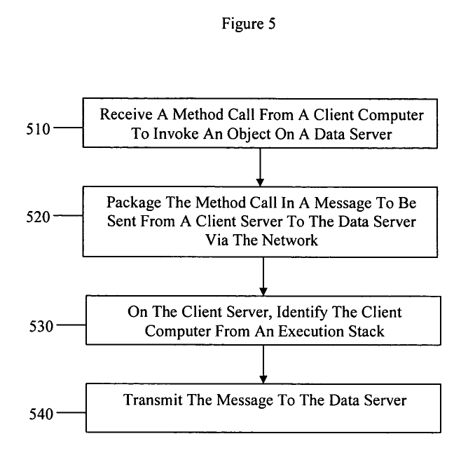

FIG. 5 depicts an embodiment of a method of identifying a message source in a network. The method includes, as shown at step 510, receiving a method call from a client computer 110 to invoke an object on a data server 140. The method further includes, as shown at step 520, packaging the method call in a message to be sent from a client server 120 to the data server 140 via the network. At step 530, on the client server 120, the client computer 110 is identified from an execution stack. Finally, at step 540, the message is transmitted to the data server 140. It should be appreciated that various steps 510 to 540 may be performed in a like manner as previously described in reference to FIG. 2, or may be performed in a different manner as would be readily apparent to one of ordinary skill in the art after reading this disclosure.

Additionally, according to one embodiment of the present invention, by providing a graphical developing platform along with the message source identification technique disclosed by the present application, a software developer can more easily debug errors in software being developed or debugged. This is due, in part, to the graphical depiction of the entire network, including identifying the source of messages sent between various theoretical users/computers operating thereon. Hence, component software can be developed more easily and at a cheaper cost than with conventional techniques by the administrator being able to see the entire network operating as if in real-time.

The foregoing description of various embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated.

1. A method of identifying a message source in a network, comprising:
receiving a method call from a client computer to invoke an object on a data server;
packaging the method call in a message to be sent from a client server to the data server via the network;
on the client server, identifying the client computer from an execution stack; and
transmitting the message to the data server.

2. The method of claim 1, further comprising:
on the client computer, generating the method call to invoke the object on the data server.

3. The method of claim 2, wherein transmitting the message to the data server transmits an identifier of an object on the client computer invoking the object on the data server along with the message.

4. The method of claim 3, wherein the identifier is stored in a header of the message.

5. The method of claim 3, wherein the identifier comprises a fully qualified class name.

6. The method of claim 1, wherein the message comprises a simple object access protocol (SOAP) message.

7. The method of claim 6, wherein packaging the method call in a message comprises building up a SOAP request.

8. The method of claim 7, wherein transmitting the message comprises implementing a SOAP application programming interface (API).

9. The method of claim 8, wherein the SOAP API comprises a messaging API.

10. The method of claim 2, further comprising:
displaying a Web service graphical component representing the object; and
displaying an interconnecting graphical component representing an associated interaction between the client computer and the data server.

11. A client server configured to transmit messages to a data server via a network, comprising:
a client computer interface configured to receive a method call from a client computer to invoke an object on the data server; and
a data processing unit coupled to the client computer interface, the data processing unit being configured to:
package the method call in a message to be sent from the client server to the data server via the network;
identify the client computer from an execution stack; and
transmit the message to the data server.

12. The client server of claim 11, wherein the message is transmitted along with an identifier of an object on the client computer invoking the object on the data server.

13. The client server of claim 12, wherein the identifier is stored in a header of the message.

14. The client server of claim 12, wherein the identifier comprises a fully qualified class name.

15. The client server of claim 11, wherein the message comprises a simple object access protocol (SOAP) message.

16. The client server of claim 15, wherein packaging the method call in a message comprises building up a SOAP request.

17. The client server of claim 16, wherein transmitting the message comprises implementing a SOAP application programming interface (API).

18. The client server of claim 17, wherein the SOAP API comprises a messaging API.

19. A program product comprising machine-readable program code for causing, when executed, a computer to graphically emulate a network including at least a client computer, a client server, and a data server, the program product graphically emulating the network performing method steps of:
on the client computer, generating a method call to invoke an object on the data server;
packaging the method call in a message to be sent from the client server to the data server via the network;
on the client server, identifying an identifier of an object on the client computer invoking the object on the data server the client computer from an execution stack; and
transmitting the message to the data server.

20. The program product of claim 19, wherein the identifier comprises a fully qualified class name.

21. The program product of claim 19, wherein the message comprises a simple object access protocol (SOAP) message.

22. An apparatus configured to identify a message source in a network, comprising:
means for receiving a method call from a client computer to invoke an object on a data server;
means for packaging the method call in a message to be sent from a client server to the data server via the network;
means, on the client server, for identifying the client computer from an execution stack; and
means for transmitting the message to the data server.
